(19) United States
(12) Patent Application Publication
(10) Pub. No.: US 2007/0115939 A1
(43) Pub. Date: May 24, 2007

(54) Network on chip system employing an advanced extensible interface protocol

(75) Inventors: Beom-hak Lee, Seoul (KR); Eui-seok Kim, Suwon-si (KR); Sang-woo Rhim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/434,188

(22) Filed: May 16, 2006

(30) Foreign Application Priority Data
Oct. 12, 2005 (KR) 10-2005-0096105

(51) Int. Cl. H04L 12/66

(52) U.S. Cl. 370/352

(57) ABSTRACT

A network on chip system employing an advanced extensible interface protocol is provided. The network on chip system employing the advanced extensible interface protocol includes a plurality of intellectual properties (IPs) which are installed in a chip and read and write data; a router which is connected to the plurality of IPs and transmits data; and a plurality of network interfaces (NIs), each NI corresponding to a respective one of the plurality of IPs and installed between the respective IP and the router, wherein each NI is configured to process data transmitted between the respective IP and the router and to divide data provided from the respective IP into at least one packet.

### CROSS-REFERENCE TO RELATED APPLICATION

This application claims priority from Korean Patent Application No. 10-2005-0096105, filed on Oct. 12, 2005, the entire contents of which is incorporated herein by reference.

### BACKGROUND OF THE INVENTION

1. Field of the Invention

The present invention relates to a Network-on-Chip (NoC) system employing the Advanced extensible Interface (AXI) protocol. More particularly, the present invention relates to an NoC system employing the AXI protocol and enabling data to be divided into plural packets with the AXI protocol applied to the NoC, thereby supporting diverse AXI protocol functions and enhancing band utilization capability.

2. Description of the Related Art

Coping with the convergence which gradually integrates computers, communications, and broadcast, demands on conventional Application Specific Integrated Circuits (ASICs) and Application Specific Standard Products (ASSPs) have tended to move to system on chip (SoC) designs. In addition, the light-weight, thin, and high-performance trends of information technology (IT) devices have become a factor accelerating SoC industry growth.

The SoC is a technology-intensive semiconductor technology that implements a complicated system, having several conventional functions, into one chip. Various technologies are under study for SoC implementations and, specifically, a method of connecting several intellectual properties (IPs) embedded in a chip is emerging as an important topic. Here, IP refers intellectual property cores which may be embedded on a chip. These IPs are reusable virtual components which may include both digital and analog circuitry, which perform specific functions (e.g. controllers, digital signal processing, graphics).

A connection method based on a bus is typical of the conventional technology for connecting IPs. However, in a bus structure, if a specific IP uses the bus, the other IPs cannot use the bus. Therefore, accordingly, as the integration density of a chip becomes higher and the amount of information traffic between IPs is abruptly increased, the SoC using a bus structure without extensibility support encounters certain structural limitations.

As an approach for overcoming such structural limitations of the SoC using a bus structure, an NoC technology was newly proposed, which applies general network technologies within a chip to connect the IPs.

Additionally, there is an Advanced Microcontroller Bus Architecture (AMBA) by ARM. AMBA is a standard bus specification for connecting and managing the IPs in a SoC. The bus types of the AMBA include Advanced High-Performance Bus (AHB), Advanced Peripheral Bus (APB), and AXI. Of the above, the AXI is an IP interface protocol, having advanced functions such as a Multiple outstanding address function, a Data interleaving function, and the like.

When information is provided through address lines and data lines of a bus, a multiple outstanding address function is a function for allowing the utilization of idle transmission time occurring between addresses by transmitting the address of each data only once through the address lines at the same time as the data is transmitted. When several masters transmit data to one slave, the data interleaving function allows the data to be interleaved with each other at the slave, thus allowing the more efficient utilization of bandwidth as well as providing an advantage in respect of latency.

When the AXI having such functions is implemented in the NoC as an interface protocol between each IP and a switch of an NoC, the structural limitations occurring at the SoC due to the characteristics of the bus can be overcome, so the speed and reusability upon data transmissions between IPs are expected to be increased.

For this, the paper entitled “An Efficient On-Chip NI Offering Guaranteed Services, Shared-Memory Abstraction, and Flexible Network Configuration”, published January 2005 in IEEE Transactions on Computer-Aided Design of Integrated Circuits and System by Philips proposes a Network Interface (NI) and packet formats for an NoC employing the AXI.

However, the paper of Phillips only conceptually explains the devices for supporting the AXI, and focuses on the point that the AXI is used for connections between the NoC and the IP. Further, one burst is converted into one packet and then transmitted, so it is impossible to support not only diverse AXI functions such as a Multiple outstanding address function, a data interleaving function, and a data reordering function but also Write strobes (WSTRBs). Furthermore, when one burst is converted into one packet, the bandwidth utilization capability becomes lowered since the larger a burst size is, the longer the waiting time for converting the burst into the packet.

Accordingly, when the AXI is applied to a NoC system, a method is needed that can support all the functions of the AXI itself.

### SUMMARY OF THE INVENTION

An aspect of the present invention is to provide an NoC system employing the AXI protocol and enabling data to be divided into plural packets with the AXI protocol applied to the NoC, thereby supporting diverse AXI protocol functions and enhancing the band utilization capability.

According to an aspect of the present invention, there is provided a Network-on-Chip (NoC) system employing an Advanced eXtensible Interface (AXI) protocol, the system comprising a plurality of intellectual properties (IPs) which are installed in a chip and read and write data; a router connected to the plurality of IPs which transmit data; and a plurality of network interfaces (NIs), each NI corresponding to a respective IP of the plurality of IPs and installed between the respective IP and the router, wherein each NI is configured to process data transmitted between the respective IP and the router and divide data provided from the respective IP into at least one packet.

The respective NI may include a packet generator which is configured to packetize data provided from the respective IP, or to convert packets into data; and a flit generator which is configured to convert packets generated from the packet generator into flits in a format for transmission, or to convert the flits into packets.

The packet generator may include a handshake checking unit which is configured to decide whether the respective IP and its corresponding NI are in a state of enabling data transmissions; a channel identifying unit which is configured to identify through which channel of a plurality of channels connecting the respective IP and its corresponding NI the data are transmitted; a packet unit which is configured to packetize into at least one packet the data from the respective IP through the channel provided by the channel identifying unit; a de-packet unit which is configured to restore packets provided from the router into original data; and a packet buffer which is configured to store packets from the packet unit and packets from the router.

Upon data transmissions between the respective IP and its corresponding NI, the handshake checking unit may generate a VALID handshake signal and a READY handshake signal which indicate whether the data transmissions of the respective IP and its corresponding NI are available.

Upon the data transmissions from the respective IP to its corresponding NI, the handshake checking unit may change the VALID handshake signal depending on whether the respective IP may transmit data, and changes the READY handshake signal depending on whether the NI corresponding to the respective IP may transmit data.

Upon the data transmissions from the corresponding NI to the respective IP, the handshake checking unit may change the VALID handshake signal depending on whether the respective NI may transmit data and changes the READY handshake signal depending on whether the respective IP may transmit data.

Depending on information contained in the data and the packet, the channel identifying unit may decide through which channel of a Write Address (WA) channel, a Write data (W) channel, a Write Response (B) channel, a Read Address (RA) channel, and a Read Data (R) channel, the data and the packet are transmitted.

According to a channel identified by the channel identifying unit and data provided from the respective IP, the packet unit may generate one of a read request packet transmitted to the AR channel, a write request packet transmitted to the WA channel, a read packet transmitted to the R channel, a write packet transmitted to the W channel, and a write response packet transmitted to the B channel.

The read request packet and the write request packet may include a header containing at least one of a packet type, transmitter's information, data length, data size, data type, information on whether a lock is set, information on whether cache memory is available and security level, and a payload containing a read memory address in the read request packet and a write memory address in the write request packet.

The read packet may include a header containing at least one of a packet type, information on a read target IP, information on whether the read request packet is successfully transmitted and information on whether a burst is a last one, and a payload containing read data.

The write packet may include a header containing at least one of a packet type, information on a write target IP, Write Strobe (WSTRB) information and information on whether a burst is a last one, and a payload containing write data.

The read response packet may include a header containing at least one of a packet type, information on a response IP and information on whether a request has been accepted.

The flit generator may include an address decoder which is configured to convert a network address, which is contained in the packet or flit, into a memory address or vice versa; a flit unit which is configured to convert a packet, which has an address converted by the address decoder, into a flit; a de-flit unit which is configured to convert a flit provided by the router into a packet; and a flit buffer which is configured to store a flit from the flit unit and a flit from the router.

According to another aspect of the invention, a network interface device for use in a network-on-chip system employing an Advanced eXtensible Interface (AXI) protocol is provided. The device includes a packet generator which is configured to packetize data provided from an intellectual property (IP), or to convert packets into data; and a flit generator which is configured to convert packets generated from the packet generator into flits in a format for transmission, or to convert the flits into packets.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a block diagram for showing relations between an NI and a router according to an exemplary embodiment of the present invention;

FIG. 2 is a block diagram for showing the NI of a NoC system employing the AXI protocol according to an exemplary embodiment of the present invention;

FIGS. 3A to 3D are views for showing packet structures transmitted through each channel;

FIG. 3E is a view showing a flit structure;

FIG. 4A is a system configuration view for showing data processing procedures in the NoC system according to an exemplary embodiment of the present invention;

FIG. 4B is a view for showing signals generated in the procedures of FIG. 4A;

FIG. 5A is a system configuration view for showing divisions of a burst in the NoC system according to another exemplary embodiment of the present invention;

FIG. 5B is a signal diagram according to the exemplary embodiment of FIG. 5A;

FIG. 6 is a view for showing signals occurring as the present NoC system divides a burst according to yet another exemplary embodiment of the present invention;

FIG. 7 is a view for showing signals occurring as the present NoC system divides a burst according to still another exemplary embodiment of the present invention; and

FIG. 8 is a system configuration view for showing data processing procedures at an AXI slave upon data transmissions in the NoC system according to an exemplary embodiment of the present invention.

### DETAILED DESCRIPTION OF EXEMPLARY EMBODIMENTS

Hereinafter, the present invention will be described in detail with reference to the accompanying drawings.

In the present disclosure, for convenient explanations, IPs in a chip are divided into a controlling IP and a controlled IP in writing and reading data, and the controlling IP and the controlled IP are referred to as an AXI master and an AXI slave respectively. The AXI master and the AXI slave transmit data through an NoC router, and an NI is installed between the AXI master and the NoC router and between the NoC router and the AXI slave respectively.

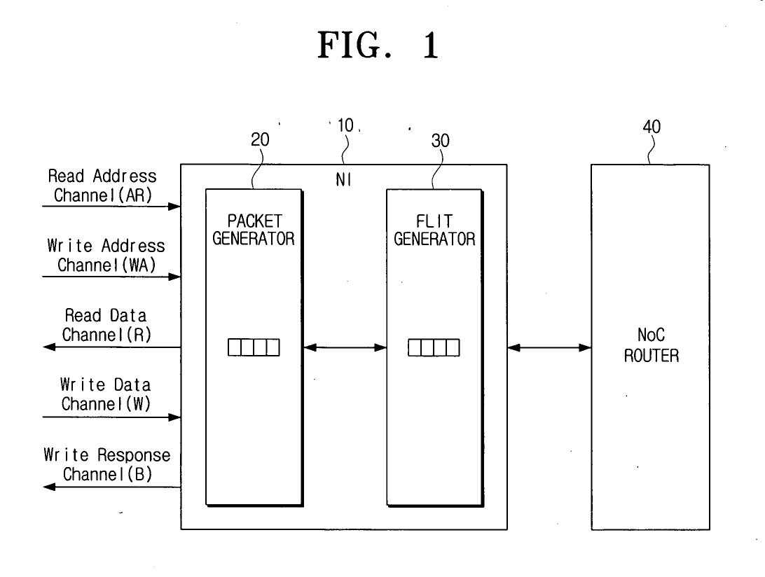

FIG. 1 is a block diagram for showing relations between an NI and a router according an exemplary embodiment to the present invention. As shown in FIG. 1, the NI 10 includes a packet generator 20 and a flit generator 30, and the packet generator 20 exchanges packets with the flit generator 30, and the NI 10 exchanges flits with the NoC router 40.

Meanwhile, the NI 10 and the AXI master and the NI 10 and the AXI slave are connected via five channels respectively, and the channels are a Write Address (WA) channel, a Write Data (W) channel, a Write Response (B) channel, a Read Address (AR) channel, and a Read Data (R) channel.

In order to write data into the AXI slave, the AXI master provides a packet requesting for a data write through the WA channel and, if provided with a packet allowing the data write from the AXI slave through the B channel, the AXI master provides the AXI slave with data through the W channel. On the contrary, when reading data, the AXI master requests the AXI slave for a data read by using the AR channel, and the AXI slave provides the AXI master with data through the R channel.

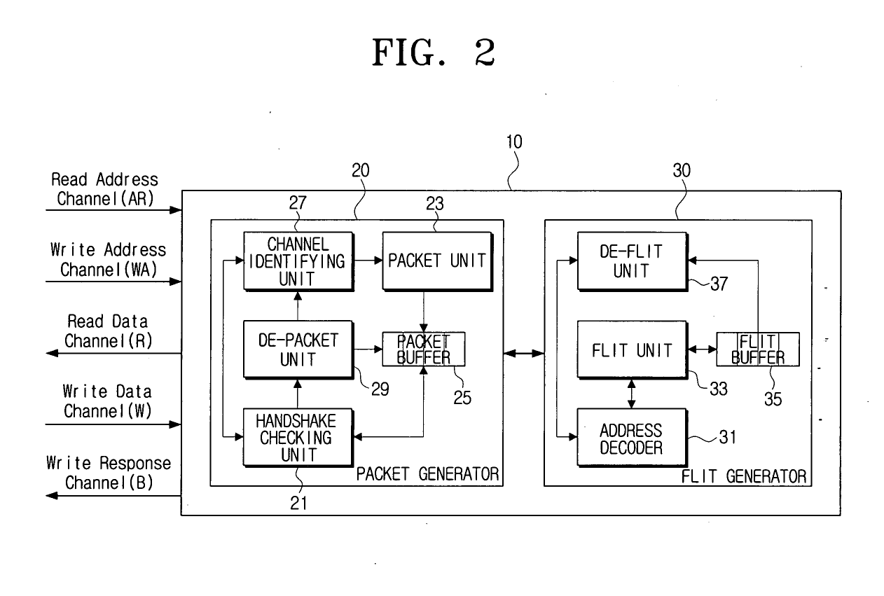

FIG. 2 is a block diagram for showing the NI of a NoC system employing the AXI protocol according to an exemplary embodiment of the invention, the NI being connected to each channel and transmitting packets.

The packet generator 20 of the NI 10 processes the packets transmitted between the AXI master and the NoC router 40 and between the NoC router 40 and the AXI slave, and the flit generator 30 converts the packets of the packet generator 20 into flits, or converts flits into packets. Such an NI 10 is installed at the AXI master and AXI slave sides in the same structure.

The packet generator 20 includes a handshake checking unit 21, a channel identifying unit 27, a packet unit 23, a packet buffer 25, and a de-packet unit 29.

The handshake checking unit 21 generates a VALID handshake signal and a READY handshake signal, and all the above five channels use the same VALID handshake signal and READY handshake signal in order to transmit data and control information. The handshake checking unit 21 checks the capacity of the packet buffer 25 and decides if packets can be stored, and generates the VALID handshake signal and the READY handshake signal.

The handshake checking unit 21, when the AXI master transmits data to the NI 10, changes the VALID handshake signal depending on whether or not the AXI master transmits data, and changes the READY handshake signal depending on a state of the packet buffer 25 of the NI 10. The handshake checking unit 21 outputs the VALID handshake signal of high level if the AXI master transmits data, and outputs the READY handshake signal of high level if the packet buffer 25 of the NI 10 can store data.

Further, the handshake checking unit 21, when the NI 10 transmits data to the AXI master, changes the VALID handshake signal depending on whether or not the NI 10 transmits data, and changes the READY handshake signal if the AXI master can receive data.

Accordingly, only when both the VALID handshake signal and the READY handshake signal become high, data or control information is transmitted.

The channel identifying unit 27 identifies through which channel the data, which are received through the channels that are connected to the NI 10, are inputted, and provides the packet unit 23. That is, the channel identifying unit 27 decides that the data are provided through any of the WA channel, W channel, B channel, AR channel, and R channel according to the information inputted from each channel. For example, if the input data contain information on whether a lock (LOCK) is set (AxLOCK), whether a cache memory can be used (AxCACHE), a security level (AxPROT), and the like, the channel identifying unit 27 decides that the corresponding data are provided through the WA channel or the AR channel. Further, the channel identifying unit 27 decides that the data containing whether a read request packet is successfully transmitted (RRESP) are provided through the R channel, decides that the data containing WSTRB bits are provided through the W channel, and decides that the data containing whether a request is accepted (BRESP) are provided through the B channel.

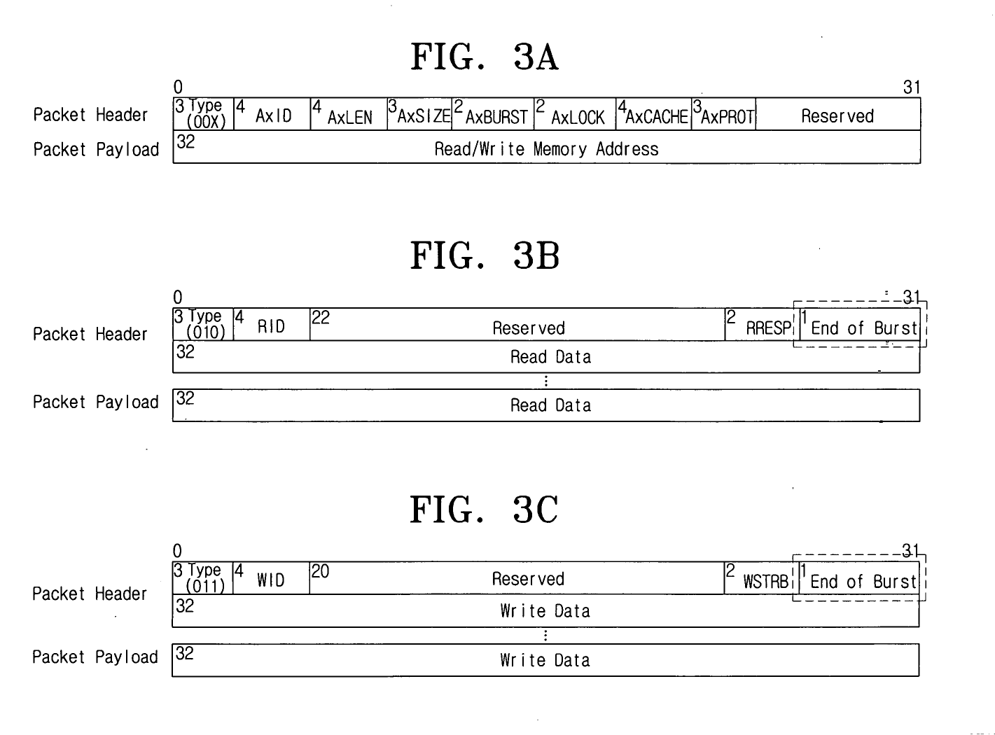

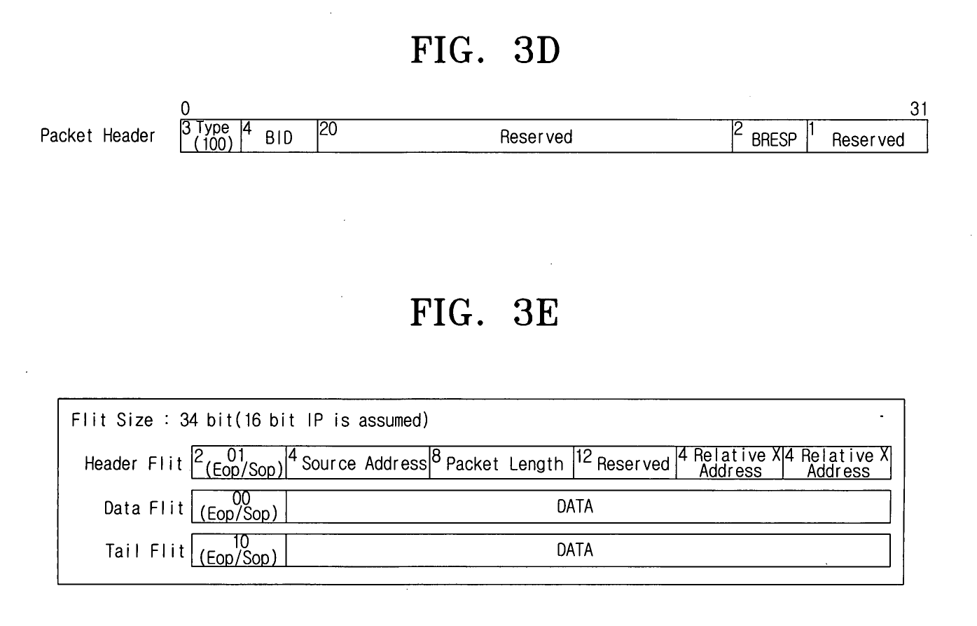

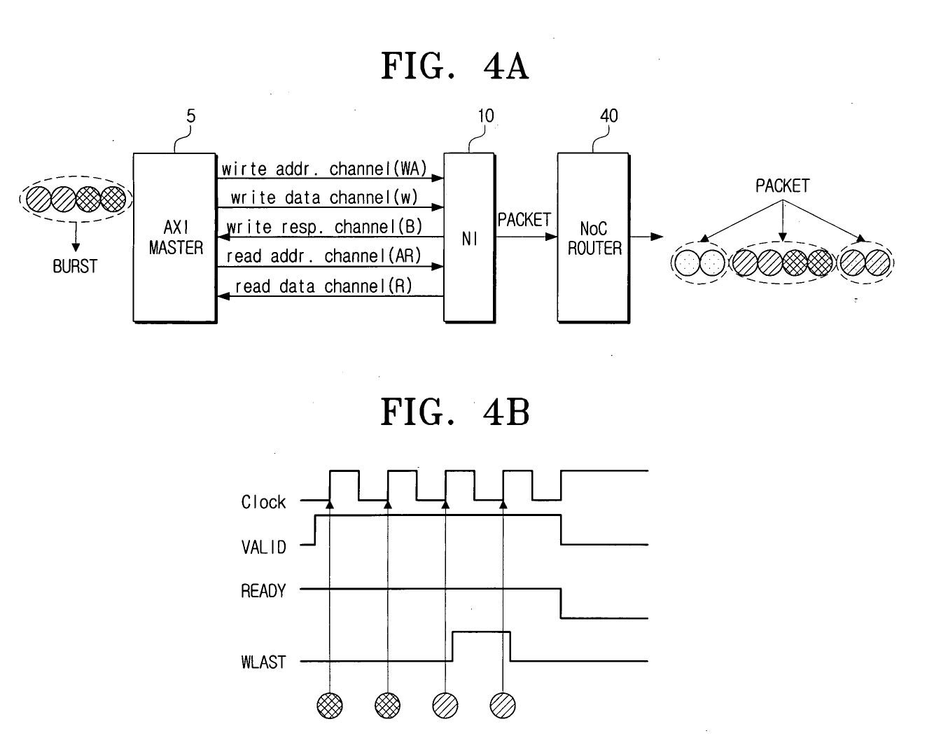

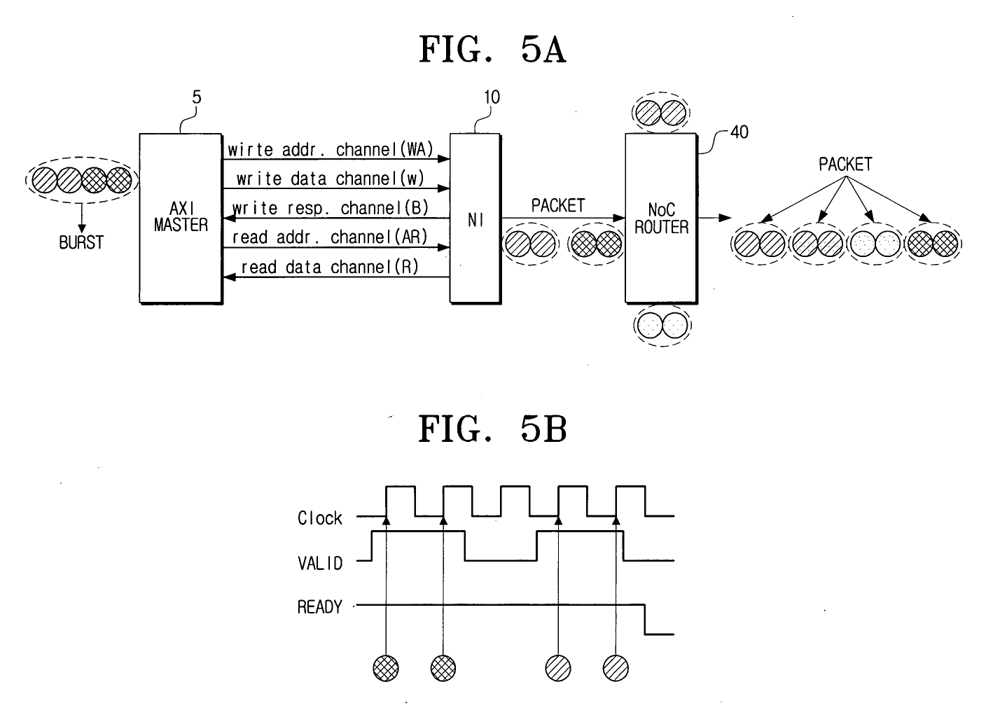

The packet unit 23 generates the packets shown in FIGS. 3A to 3D, using the data inputted through any of the channels and the channel confirmed by the channel identifying unit 27. The packet unit 23 determines a packet type contained in each packet header according to a channel type identified by the channel identifying unit 27, and processes the provided data to generate packets. The packet unit 23 can generate one or more packets from one burst of data depending on the conditions shown in FIGS. 4 to 7 which will be described later.

FIGS. 3A to 3D are views for showing packet structures transmitted through each channel.

FIG. 3A is a view for showing the structures of a read request packet and a write request packet transmitted through the WA channel and the AR channel. The read request packet and write request packet are configured in the same format. The header contains information on the packet type (Type), transmitter's ID (AxID), data length (AxLEN), data size (AxSIZE), data type (AxBURST), whether a lock (LOCK) is set (AxLOCK), whether cache memory can be used (AxCACHE), security level (AxPROT), and a reserved section (Reserved), and the payload contains a read or a write memory address. The packet type indicates any of a read request packet, a write request packet, a read packet, a write packet, and a write response packet, and whether a lock (LOCK) is set (AxLOCK) indicates whether a lock is set so that only a specific AXI master or AXI slave may receive packets. Whether cache memory can be used (AxCACHE) indicates whether cache memory, in addition to memory, can be used, and the security level (AxPROT) indicates whether to protect corresponding packets and the security level for protecting packets.

FIG. 3B is a view for showing the structure of a read packet transmitted through the R channel. The packet header contains a packet type (Type), an ID of an AXI slave (RID) performing a read operation according to a request of the AXI master, a reserved section (Reserved), whether the read request packet is successfully transmitted (RRESP), and information for identifying whether the burst is a last one (End of Burst). The RRESP indicates whether the read request packet is successfully transmitted, whether a slave error has occurred, and whether an address error has occurred. The payload of the read packet contains read data.

FIG. 3C is a view for showing the structure of a write packet transmitted through the W channel. The packet header of the write packet contains a packet type (Type), ID of an AXI slave (WID) being the target of write, a reserved section (Reserved), WSTRB bits (WSTRB), and information for identifying whether the burst is the last one (End of Burst), and the payload contains write data.

FIG. 3D is a view for showing the structure of a read response packet transmitted through the B channel. The read response packet has only a header, and the header contains information such as packet type (Type), ID of a responding AXI slave (BID), a reserved section (Reserved), whether the request has been accepted (BRESP), and another reserved section (Reserved).

The de-packet unit 29 is provided with packets from the flit generator 30, and processes the provided packets to restore the original data format provided by the AXI master or the AXI slave. The de-packet unit 29 provides the channel identifying unit 27 with the restored data.

The packet buffer 25 stores the packets generated by the packet unit 23 or stores the packets provided by the flit generator 30.

Meanwhile, the flit generator 30 contains an address decoder 31, flit unit 33, de-flit unit 37, and flit buffer 35.

The address decoder 31 converts a memory address into a network address or vice versa. When the packet generator 20 provides the flit generator 30 with packets, the address decoder 31 converts the memory address contained in the packet into a network address, and, when flits are provided from the router 40 to the NI 10, the address decoder 31 converts the network address contained in the flit into a memory address.

The flit unit 33 is provided with a packet having a converted address, and forms a flit shown in FIG. 3E. As shown in FIG. 3E, the flit contains a header flit, a data flit, and a tail flit, and the head of each flit contains two bits indicating the header flit, data flit, and tail flit. Of the above flits, the header flit contains eight-bit address information representing a destination address in XY coordinates, and the data flit and the tail flit carry data.

The de-flit unit 37 restores the flit provided by the NoC router 40 to the format of a packet generated by the packet generator 20, and provides the packet generator 20 with the restored packet.

The flit buffer 35 stores the flit generated by the flit unit 33, or the flit provided by the NoC router 40.

The process of transmitting data by use of the NI 10 configured as above will now be described.

First, if the AXI master transmits write request data, write data, or read request data to the NI 10 through any of the WA channel, W channel, and AR channel, the packet generator 20 and the flit generator 30 of the NI 10 process data, and generate packets and flits.

The handshake checking unit 21 of the packet generator 20 identifies a signal received from the AXI master and a remaining capacity of the packet buffer 25, and decides whether the data can be transmitted. If both the AXI master and the NI can transmit the data as a result of the decision, the handshake checking unit 21 generates the VALID handshake signal and the READY handshake signal of high level, i.e., drives those signals high. Next, the channel identifying unit 27 identifies through which channel of the five channels the data has been provided on, and provides the packet unit 23 with the channel information. The packet unit 23 generates packets with formats shown in FIGS. 3A to 3D according to the channel and the provided data. One or more packets are generated from data of one burst. The generated packets are temporarily stored in the packet buffer 25, and then transferred to the flit generator 30.

The address decoder 31 of the flit generator 30 converts a memory address contained in the packets into a network address, and the flit unit 33 converts the packets into a flit format for convenient transmissions. The address decoder can form only the header flit among the header flit, data flit, and tail flit, or it can form all the flits. The flit buffer 35 stores the generated flits.

The flits stored in the flit buffer 35 are transmitted to the NoC router 40, and the flits arrived at the NoC router 40 are transmitted again to the AXI slave via the NI 10. In the NI 10 on the side of the AXI slave, a process reverse to that of the NI 10 on the side of the AXI master side is performed.

If the flits are entered into the NI 10 on the side of the AXI slave, the flit buffer 35 of the flit generator 30 stores the flits, and the de-flit unit 37 restores the flits in a packet format. Further, the address decoder 31 converts a network address into a memory address, and provides the memory address to the de-packet unit 29. The restored packets are transferred to the packet generator 20, and stored into the packet buffer 25. The de-packet unit 29 of the packet generator 20 converts the packets into the original data, and the channel identifying unit 27 identifies the channel, and provides the de-packet unit 29 with the information. The AXI master is provided with the data restored by the de-packet unit 29 through the identified channel.

In the NoC system provided with the NI 10 employing AXI as above, exemplary embodiments which will be described as below can be implemented when data are transmitted according to the implementation of the NI 10 having a structure described above.

FIG. 4A is a system configuration view for showing data processing procedures in the NoC system according to a first exemplary embodiment of the present invention.

As shown in FIG. 4A, when the AXI master 5 transmits one burst of data, the data is provided to the NI 10 through the channel corresponding to the type of the data. The NI 10 converts the data into packets through the process described above, and thus, one burst of data is converted into one packet. If the packets so generated are provided to the NoC router 40, the NoC router 40 sequentially transmits the packets received from several AXI masters 5 to the NI 10 on the side of the AXI slave.

The individual signals in such a transmission process will now be described. As shown in FIG. 4B, both the VALID handshake signal and the READY handshake signal are outputted in a high level all the time while one burst is transmitted, so one burst can be converted into one packet. When a packet is completely transmitted, the WLAST signal is outputted in the high level.

The exemplary embodiment of FIG. 4 shows the conversions of one burst into one packet. As in the Phillips's paper, the NoC system of the present invention can convert one burst of data into one packet for transmission if both the VALID handshake signal and the READY handshake signal are in the high level all the time while one burst of data is transmitted.

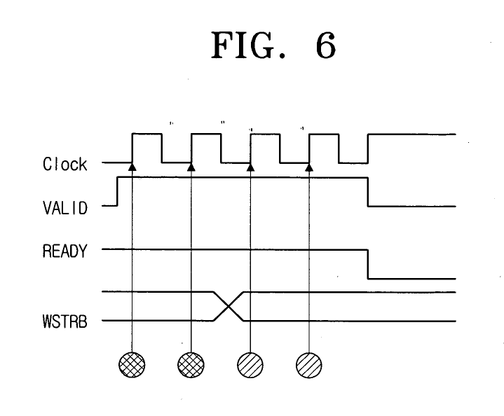

FIG. 5A is a system configuration view for showing divisions of a burst in the NoC system according to a second exemplary embodiment of the present invention.

When the AXI master 5 transmits data, the handshake checking unit 21 of the NI 10 checks the remaining capacity of the packet buffer 25, and checks if the AXI master 5 can transmit data. As a result of the check, if both the AXI master 5 and the NI 10 can transmit data, the handshake checking unit 21 generates the VALID handshake signal and the READY handshake signal in the high level, i.e., they are driven high, to transmit data. If the AXI master 5 is interrupted with certain occasions during transmitting data as above, the handshake checking unit 21 generates a low-level VALID handshake signal. Then, if the VALID handshake signal becomes low, the packet unit 23 converts the data received before the interruption into packets. When the VALID handshake signal becomes high, the packet unit 23 receives data and then generates packets again.

Accordingly, as shown in FIG. 5B, when the VALID handshake signal changes from high to low and then to high again, one burst of data is converted into two packets as shown in FIG. 5A. If the VALID handshake signal more frequently changes, the number of packets is increased.

FIG. 6 is a view for showing signals occurring as the present NoC system divides a burst according to a third exemplary embodiment of the present invention.

If data transmitted by the AXI master 5 is SPARSE data, a WSTRBE function is performed according to communication regulations, and a portion in which the WSTRBE signal is inverted indicates that an arbitrary WRITE STROBES is changed to another WRITE STROBES. When the WRITE STROBES is changed in this manner, data can be divided for generation of separate packets.

Accordingly, as shown in FIG. 5A, one burst of data is divided into plural packets in the NI 10, and transferred to the NoC router 40.

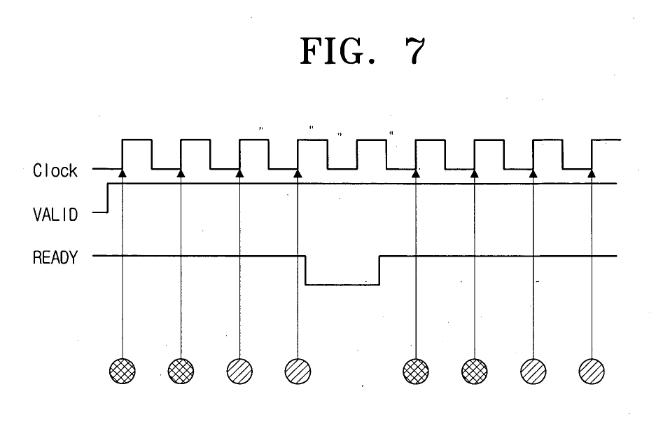

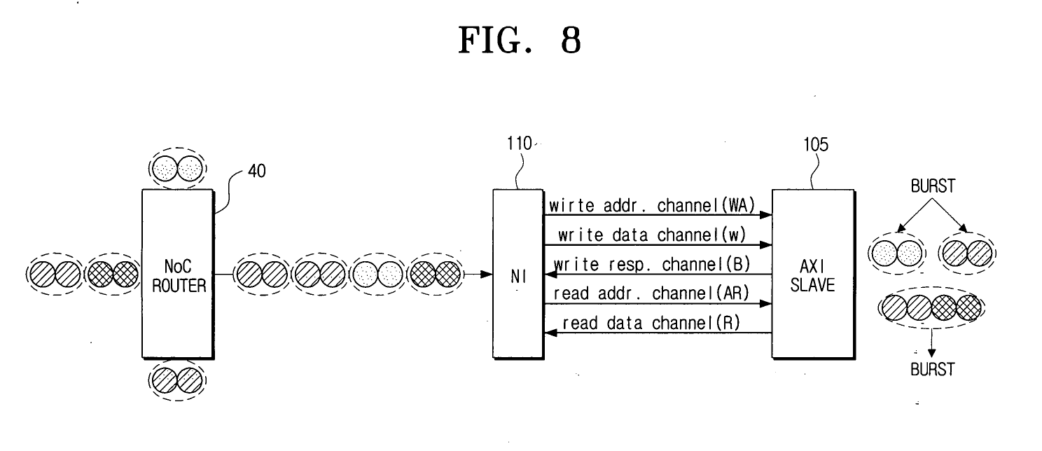

FIG. 7 is a view for showing signals occurring as the present NoC system divides a burst according to a fourth exemplary embodiment of the present invention.

As shown in FIG. 7, if the READY handshake signal is changed from high to low while the VALID handshake signal maintains high, i.e., the packet buffer 25 of the NI 10 has no remaining capacity while the AXI master 5 is transmitting data, the packet unit 23 generates packets from the data transmitted until then. Next, if the READY handshake signal is changed to high again, the packet unit 23 receives data and generates other packets.

FIG. 8 is a system configuration view for showing data processing procedures at the AXI slave upon data transmissions in the NoC system according to an exemplary embodiment of the present invention.

If one burst of data is divided into plural packets and transmitted according to one of the exemplary embodiments of FIGS. 5 to 7, as shown in FIG. 8, the NoC router 40 transmits packets to the NI 110 on the side of the AXI slave 105. The NI 110 on the side of the AXI slave 105 converts the packets into data, creates one burst from the data divided into the plural packets, and transfers the burst to the AXI slave 105.

As above, the NoC system employing the AXI protocol can divide one burst of data into plural packets and transmit the packets according to the changes of transmission environments as shown in FIGS. 4 to 7. Accordingly, unlike the Phillips' paper in which one burst of data is conventionally converted into one packet and transmitted, the NoC system according to exemplary embodiments of the present invention can support not only the Multiple outstanding address function, data interleaving function, and data reordering function, but also WSTRB (Write strobe). In addition, the NoC system divides one burst into plural packets, thereby shortening the waiting time for transmissions, and enhancing the band utilization capability.

As aforementioned, the NoC system of the present invention can support not only the Multiple outstanding address function, data interleaving function, and data reordering function, but also WSTRB (Write strobe), and shorten the waiting time for transmission and enhance the band utilization capability.

Further, the foregoing embodiments and advantages are merely exemplary and are not to be construed as limiting the present invention. The present teaching can be readily applied to other types of apparatuses. Also, the description of exemplary embodiments of the present invention is intended to be illustrative, and not to limit the scope of the claims, and many alternatives, modifications, and variations will be apparent to those skilled in the art.

What is claimed is:

1. A Network-on-chip (NoC) system employing an Advanced extensible Interface protocol (AXI), the system comprising:
a plurality of intellectual properties (IPs) which are installed in a chip and read and write data;
a router which is connected to the plurality of IPs and transmits data; and
a plurality of network interfaces (NIs), each NI corresponding to a respective IP of the plurality of IPs and installed between the respective IP and the router, wherein each NI is configured to process data transmitted between the respective IP and the router and divide data provided from the respective IP into at least one packet.

2. The NoC system as claimed in claim 1, wherein the NI comprises:
a packet generator which is configured to packetize data provided from the respective IP, or to convert packets into data; and
a flit generator which is configured to convert packets generated from the packet generator into flits in a format for transmission, or to convert the flits into packets.

3. The NoC system as claimed in claim 2, wherein the packet generator comprises:
a handshake checking unit which is configured to decide whether the respective IP and its corresponding NI are in a state of enabling data transmissions;
a channel identifying unit which is configured to identify through which channel of a plurality of channels connecting the respective IP and its corresponding NI the data are transmitted;
a packet unit which is configured to packetize into at least one packet the data from the respective IP through the channel provided by the channel identifying unit;
a de-packet unit which is configured to restore packets provided from the router into original data; and
a packet buffer which is configured to store packets from the packet unit and packets from the router.

4. The NoC system as claimed in claim 3, wherein, upon data transmissions between the respective IP and its corresponding NI, the handshake checking unit generates a VALID handshake signal and a READY handshake signal which indicate whether the data transmissions of the respective IP and its corresponding NI are available.

5. The NoC system as claimed in claim 3, wherein, upon the data transmissions from the respective IP to its corresponding NI, the handshake checking unit changes a VALID handshake signal depending on whether the respective IP can transmit data, and changes a READY handshake signal depending on whether the NI corresponding to the respective IP can transmit data.

6. The NoC system as claimed in claim 3, wherein, upon the data transmissions from the corresponding NI to the respective IP, the handshake checking unit changes a VALID handshake signal depending on whether the respective NI can transmit data and changes a READY handshake signal depending on whether the respective IP can transmit data.

7. The NoC system as claimed in claim 3, wherein, depending on information contained in the data and the packet, the channel identifying unit decides through which channel of a Write Address (WA) channel, a Write data (W) channel, a Write Response (B) channel, a Read Address (RA) channel, and a Read Data (R) channel, the data and the packet are transmitted.

8. The NoC system as claimed in claim 3, wherein, according to a channel identified by the channel identifying unit and data provided from the respective IP, the packet unit generates one of a read request packet transmitted to a AR channel, a write request packet transmitted to a WA channel, a read packet transmitted to a R channel, a write packet transmitted to a W channel, and a write response packet transmitted to a B channel.

9. The NoC system as claimed in claim 8, wherein the read request packet and the write request packet comprise:
a header containing at least one of a packet type, transmitter's information, data length, data size, data type, information on whether a lock is set, information on whether cache memory is available and security level; and
a payload containing a read memory address in the read request packet and a write memory address in the write request packet.

10. The NoC system as claimed in claim 8, wherein the read packet comprises:
a header containing at least one of a packet type, information on a read target IP, information on whether the read request packet is successfully transmitted and information on whether a burst is a last one; and
a payload containing read data.

11. The NoC system as claimed in claim 8, wherein the write packet comprises:
a header containing at least one of a packet type, information on a write target IP, Write Strobe (WSTRB) information, and information on whether a burst is a last one; and
a payload containing write data.

12. The NoC system as claimed in claim 8, wherein the read response packet includes a header containing at least one of a packet type, information on a response IP and information on whether a request has been accepted.

13. The NoC system as claimed in claim 2, wherein the flit generator comprises:
an address decoder which is configured to convert a network address, which is contained in the packet or flit, into a memory address or vice versa;
a flit unit which is configured to convert a packet, which has an address converted by the address decoder, into a flit;
a de-flit unit which is configured to convert a flit provided by the router into a packet; and
a flit buffer which is configured to store a flit from the flit unit and a flit from the router.

14. A network interface device for use in a network-on-chip system employing an Advanced extensible Interface (AXI) protocol, the device comprising:
a packet generator which is configured to packetize data provided from an intellectual property (IP), or to convert packets into data; and
a flit generator which is configured to convert packets generated from the packet generator into flits in a format for transmission, or to convert the flits into packets.

15. The network interface device as claimed in claim 14, wherein the packet generator comprises:
a handshake checking unit which is configured to decide whether the IP and the network interface device are in a state of enabling data transmissions;
a channel identifying unit which is configured to identify through which channel of a plurality of channels connecting the IP and the network interface device the data are transmitted;
a packet unit which is configured to packetize into at least one packet the data from the IP through the channel provided by the channel identifying unit;
a de-packet unit which is configured to restore packets provided from a router into original data; and
a packet buffer which is configured to store packets from the packet unit and packets from the router.

16. The network interface device as claimed in claim 15, wherein, according to a channel identified by the channel identifying unit and data provided from the IP, the packet unit generates one of a read request packet transmitted to an AR channel, a write request packet transmitted to a WA channel, a read packet transmitted to an R channel, a write packet transmitted to a W channel, and a write response packet transmitted to a B channel.

17. The network interface device as claimed in claim 14, wherein the flit generator comprises:
an address decoder which is configured to convert a network address, which is contained in the packet or flit, into a memory address or vice versa;
a flit unit which is configured to convert a packet, which has an address converted by the address decoder, into a flit;
a de-flit unit which is configured to convert a flit provided by a router into a packet; and
a flit buffer which is configured to store a flit from the flit unit and a flit from the router.
